(19) United States
(12) Patent Application Publication
(10) Pub. No.: US 2023/0394418 A1
(43) Pub. Date: Dec. 7, 2023

(54) DELIVERY SYSTEM

(71) Applicant: DENSO CORPORATION, Kariya-city (JP)

(72) Inventors: Cheet Voon CHU, Kariya-city (JP); Ryoichi FUJIWARA, Kariya-city (JP); Kunie NAKAE, Kariya-city (JP); Masahiro SUZUKI, Kariya-city (JP); Tatsuhiko NISHINO, Kariya-city (JP)

(21) Appl. No.: 18/453,753

(22) Filed: Aug. 22, 2023

Related U.S. Application Data
(63) Continuation of application No. PCT/JP22/05376, filed on Feb. 10, 2022.

(30) Foreign Application Priority Data
Feb. 26, 2021 (JP) 2021-029799
Feb. 7, 2022 (JP) 2022-017220

(51) Int. Cl. G06Q 10/0832; G06F 1/28; F25D 11/00

(52) U.S. Cl. CPC G06Q 10/0832; G06F 1/28; F25D 11/003

(57) ABSTRACT

A delivery box stores a delivery item and can be moved to a delivery destination. A management server manages delivery of the delivery item using the delivery box. The delivery box includes a power supply, a temperature adjustment unit adjusting temperature of the delivery item with a power supplied from the power supply, and a transmission/reception unit transmitting/receiving information to/from the management server via a communication network. The management server includes a delivery possibility determination unit executing delivery possibility determination of determining whether temperature of the delivery item can be maintained at a predetermined temperature by the temperature adjustment unit until the delivery item is delivered to the delivery destination. The delivery possibility determination unit executes the delivery possibility determination based on at least the power supply information relating to power supplied from the power supply acquired from the delivery box.

### CROSS REFERENCE TO RELATED APPLICATION

The present application is a continuation application of International Patent Application No. PCT/JP2022/005376 filed on Feb. 10, 2022, which designated the U.S. and claims the benefit of priority from Japanese Patent Applications No. 2021-029799 filed on Feb. 26, 2021 and No. 2022-017220 filed on Feb. 7, 2022. The entire disclosures of all of the above applications are incorporated herein by reference.

### TECHNICAL FIELD

The present disclosure relates to a delivery system that is to deliver a delivery item which needs a temperature control.

### BACKGROUND

Conventionally, a known delivery system is used for delivering a delivery item which needs a temperature control.

### SUMMARY

According to an aspect of the present disclosure, a delivery system comprises: a delivery box configured to store a delivery item and to be moved to a delivery destination; and a management server configured to manage delivery of the delivery item using the delivery box.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating the configuration of a delivery system of a first embodiment.

FIG. 2 is a block diagram illustrating travel paths of a delivery box in the first embodiment.

FIG. 3 is a block diagram illustrating the configuration of a management server.

FIG. 4 is a block diagram illustrating the configuration of a delivery box.

FIG. 5 is a flowchart illustrating delivery process of the first embodiment.

FIG. 6 is a flowchart illustrating the delivery process of the first embodiment.

FIG. 7 is a block diagram illustrating travel paths of a delivery box of a second embodiment.

FIG. 8 is a block diagram illustrating travel paths of a delivery box of a third embodiment.

FIG. 9 is a block diagram illustrating travel paths of a delivery box of a fourth embodiment.

FIG. 10 is a block diagram illustrating the configuration of a delivery system of a fifth embodiment.

FIG. 11 is a block diagram illustrating travel paths of a delivery box of the fifth embodiment.

FIG. 12 is a block diagram illustrating travel paths of a delivery box of a sixth embodiment.

FIG. 13 is a block diagram illustrating the configuration of a delivery system of a seventh embodiment.

FIG. 14 is a block diagram illustrating the configuration of a delivery box of the seventh embodiment.

FIG. 15 is a block diagram illustrating the configuration of a portable terminal of the seventh embodiment.

FIG. 16 is a flowchart illustrating delivery process of the seventh embodiment.

FIG. 17 is a flowchart illustrating the delivery process of the seventh embodiment.

FIG. 18 is a flowchart illustrating delivery process of an eighth embodiment.

### DETAILED DESCRIPTION

Hereinafter, examples of the present disclosure will be described.

In a delivery system for delivering a delivery item which needs a temperature control, the temperature of a delivery item stored in a delivery box has to be adjusted.

As methods of performing such adjustment of the temperature of a delivery item, passive cooling using an insulating material, a cooling storage material, and the like and active cooling using a cooling device which is operated by a power supplied from a power supply are assumable.

In the passive cooling, however, the temperature adjustment cannot be performed and, further, the temperature adjustment capability is specified by the capacity of a cooling storage material or the like, so that the temperature adjustment capability is limited. Consequently, in the passive cooling, there is a concern that it becomes impossible to maintain a delivery item at a predetermined temperature during delivery and the quality of the delivery item decreases. Although the temperature adjustment capability can be improved by using a large amount of cooling storage material or the like in the passive cooling, in this case, the amount of delivery items which can be stored in the delivery box may largely decrease, and the delivery efficiency deteriorates.

In the active cooling, although temperature adjustment is possible, the suppliable power amount of the power supply decreases with use, and the temperature adjustment capability decreases. Due to this, also in the active cooling, there is a concern that it may become impossible to maintain a delivery item at a predetermined temperature during delivery and the quality of the delivery item deteriorates. Further, the configuration of the active cooling may be complicated so that the probability of erroneous operation, malfunction, or failure may be high. In the active cooling, by using a large-volume power supply, power shortage can be avoided. In this case, however, the amount of delivery items which can be stored in the delivery box may largely decrease, and delivery efficiency may deteriorate.

When improper handling of a delivery item, frequent opening/closing of a delivery box, delivery delay due to occurrence of an unexpected contingency such as a traffic jam, environmental change such as rise in ambient temperature, and the like may occur after start of delivery. Consequently, it would be difficult to maintain the delivery items at a predetermined temperature. Those factors exerting influence on temperature adjustment may occur commonly to the passive cooling and the active cooling.

According to an example of the present disclosure, a delivery system comprises: a delivery box configured to store a delivery item and to be moved to a delivery destination; and a management server configured to manage delivery of the delivery item using the delivery box. The delivery box includes a power supply, a temperature adjustment unit configured to adjust a temperature of the delivery item with a power supplied from the power supply, and a transmission/reception unit configured to transmit information to the management server and receive information from the management server via a communication network. The transmission/reception unit is configured to transmit power supply information including at least a suppliable power amount of the power supply to the management server. The management server includes a delivery possibility determination unit configured to execute delivery possibility determination to determine whether the temperature of the delivery item can be maintained at a predetermined temperature by the temperature adjustment unit until the delivery item is delivered to the delivery destination. The delivery possibility determination unit is configured to execute the delivery possibility determination based on at least the power supply information.

With the configuration, delivery according to the suppliable power amount of a power supply can be performed, a delivery item can be maintained at a predetermined temperature until completion of delivery, and the quality of the delivery item can be maintained. Consequently, it is unnecessary to provide a delivery box with a large-volume power supply, and both maintenance of quality of the delivery item until completion of delivery and delivery efficiency of the delivery item can be achieved.

Hereinafter, a plurality of modes for carrying out the present disclosure will be described with reference to the drawings. In some cases, in embodiments, same reference numerals are designated to parts corresponding to matters described in a foregoing embodiment and repetitive description is omitted. In the case where only a part of a configuration is described in an embodiment, the other part of the configuration described ahead of another embodiment can be applied. Not only a combination of parts clearly described that they can be combined in an embodiment but also a partial combination of embodiments, even not clearly described, are possible when there is no hinderance in the combination.

### First Embodiment

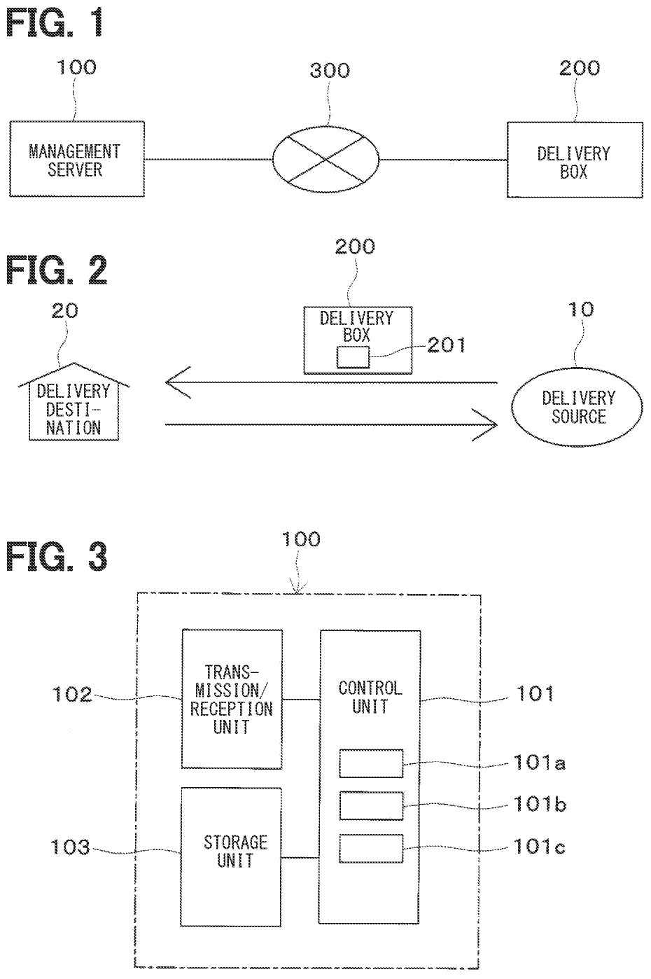

Hereinafter, a first embodiment of the present disclosure will be described with reference to the drawings. As illustrated in FIG. 1, a delivery system of the embodiment has a management server 100 and a delivery box 200.

The management server 100 is an information processing device performing delivery management of a delivery item by using the delivery box 200. The delivery box 200 is configured as a container in which a delivery item is stored. The delivery box 200 has an openable/closeable lid. By opening/closing the lid, a delivery item can be stored and taken out.

As illustrated in FIG. 2, the delivery box 200 is transferred from a delivery source 10 to a delivery destination 20 in a state where a delivery item 201 is stored. In the embodiment, by delivery of once, delivery to one delivery destination 20 is performed. The delivery box 200 is transferred by carrying the delivery box 200 by a delivery person. The delivery person can deliver the delivery item 201 with the delivery box 200 by using arbitrary moving means such as a vehicle, a motorcycle, a bicycle, public transportation, or foot.

The delivery item 201 is an item requiring temperature control for quality preservation. The delivery item 201 is an arbitrary article whose temperature has to be adjusted to a predetermined temperature and, for example, drink, food, medicine, or the like is suitable. The predetermined temperature is required temperature necessary for quality preservation of the delivery item 201 and is set in advance for each of kinds of the delivery items 201. The predetermined temperature may be a specific temperature or a temperature range having some width.

As illustrated in FIG. 1, the management server 100 and the delivery box 200 are connected via a communication network 300. As the communication network 300, for example, a wide area network such as the Internet can be used. The management server 100 and the delivery box 200 can perform communication with each other via the communication network 300 and can transmit/receive information bi-directionally.

Although not illustrated in FIG. 1, the delivery system of the embodiment is provided with a delivery process center processing a delivery request of the delivery item 201 from a delivery requester. The delivery process center transmits delivery request information to the management server 100 on the basis of an order of the delivery item 201 from a delivery requester. The delivery request information includes information relating to the kind, the number of pieces, a delivery source, a delivery destination, delivery date and time, and the like of the delivery item 201. On receipt of the delivery request information, the management server 100 performs delivery control on the delivery item 201 using the delivery box 200.

As illustrated in FIG. 3, the management server 100 is provided with a control unit 101, a transmission/reception unit (transceiver) 102, and a storage unit 103. The control unit 101 is configured by a known microcomputer (processor) including a CPU, a ROM, and a RAM and its peripheral circuits. The control unit 101 performs various computations and processes on the basis of a control program stored in the ROM to control operations of various devices to be controlled.

The control unit 101 has a delivery possibility determination unit 101a, a delivery prediction time acquiring unit 101b, and a temperature adjustable time acquiring unit 101c. The delivery possibility determination unit 101a, the delivery prediction time acquiring unit 101b, and the temperature adjustable time acquiring unit 101c are configured by the control processes executed by the control unit 101.

The delivery possibility determination unit 101a executes delivery possibility determining process of determining whether delivery of the delivery item 201 with the delivery box 200 is possible or not. The delivery prediction time acquiring unit 101b executes delivery prediction time acquiring process of acquiring a delivery prediction time which is required for delivery of the delivery item 201 with the delivery box 200. The temperature adjustable time acquiring unit 101c executes temperature adjustable time acquiring process of acquiring a temperature adjustable time in which the temperature of the delivery item 201 with the delivery box 200 can be adjusted.

The transmission/reception unit 102 is connected to the communication network 300 by wire or wirelessly. The transmission/reception unit 102 includes a transmission unit transmitting data to the outside and a reception unit receiving data from the outside.

The storage unit 103 is a writable/readable nonvolatile storage medium (for example, a magnetic disk, a flash memory, or the like). The storage unit 103 stores determination criterion information, history information, delivery item information, road information, weather information, date/time information, and the like.

The determination criterion information is information as a criterion of delivery possibility determination of determining whether the delivery item 201 with the delivery box 200 can be delivered or not. The history information is information relating to delivery of the delivery item 201 using the delivery box 200 in the past, and includes history of a result of the delivery possibility determination, history of delivery by the delivery box 200, an operation history (for example, failure history, a power consumption amount history, and the like) of a temperature adjustment unit (temperature regulator) 206 of the delivery box 200, operation history (for example, failure history, charge/discharge history, and the like) of a power supply 207, delivery history of a delivery person, and the like. The delivery item information is information relating to the delivery item 201 and includes the kind of the delivery item 201, required temperature of the delivery item 201, a delivery source, a delivery destination, and the like.

The road information is information relating to roads and includes map information, traffic information, traffic regulation information, and the like. The weather information includes weather and air temperature. The road information and the weather information is acquired from the outside by the control unit 101 and stored in the storage unit 103. The road information and the weather information includes present real-time information and future prediction information. The date/time information includes month/date, time zone, day of week, and the like and can be used for, for example, prediction of a traffic amount.

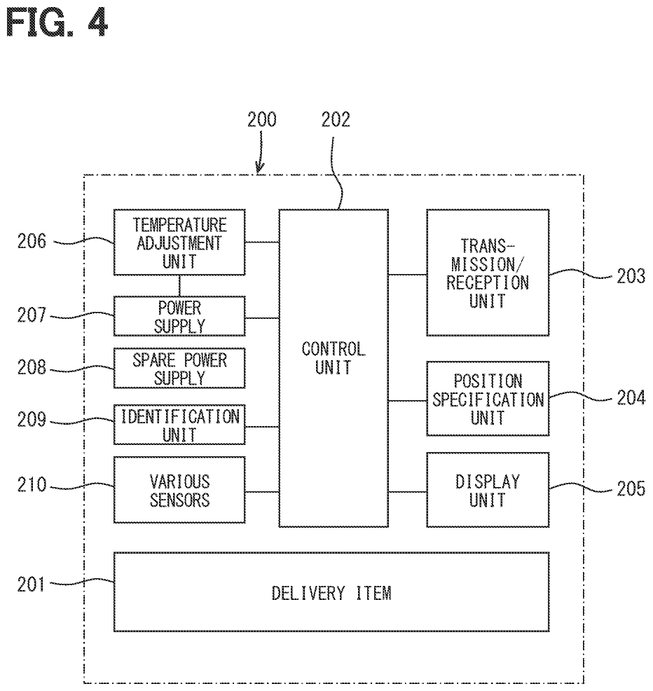

As illustrated in FIG. 4, the delivery box 200 is provided with a control unit 202, a transmission/reception unit 203, a position specification unit 204, a display unit 205, the temperature adjustment unit 206, the power supply 207, a spare power supply 208, an identification unit 209, and various sensors 210. The inside of the delivery box 200 is partitioned to a part in which the delivery item 201 is stored and a part in which components other than the delivery item 201 are stored. The part in which the delivery item 201 is stored is an air-conditioned space in which air conditioning by the temperature adjustment unit 206 is performed.

The control unit 202 is configured by a known microcomputer including a CPU, a ROM, a RAM, and the like and its peripheral circuits. The control unit 202 performs various computations and processes on the basis of a control program stored in the ROM to control operations of various devices to be controlled. The control unit 202 performs control process of the temperature adjustment unit 206. The control unit 202 has a function of diagnosing a failure of various devices to be controlled and a function of protecting the temperature adjustment unit 206. In the case where a signal is acquired from the temperature adjustment unit 206 and it is diagnosed that protection is necessary on the basis of a failure diagnosis determination value and a protection program stored in the ROM, the temperature adjustment unit 206 is protected.

The transmission/reception unit 203 is wirelessly connected to the communication network 300. The transmission/reception unit 203 includes a transmission unit transmitting data to the outside and a reception unit receiving data from the outside. The position specification unit 204 is a device specifying the present position of the delivery box 200 and, for example, a GPS can be used. The control unit 202 can acquire position information of the delivery box 200 from the position specification unit 204. The display unit 205 displays various information so that the delivery person can visually recognize it. The transmission/reception unit 203, the position specification unit 204, and the display unit 205 may be provided integrally with the delivery box 200, or provided separately from the delivery box 200 by using a portable terminal such as a smartphone.

The temperature adjustment unit 206 is a device of adjusting temperature of the delivery item 201 stored in the delivery box 200. The temperature adjustment unit 206 operates on a power supplied from the power supply 207. The temperature adjustment unit 206 of the embodiment is a cooling device for cooling the delivery item 201, and active cooling using the power supply 207 is performed. The power supply 207 can cool the cooling device independently of the power supply of a vehicle used for delivery. The power supply 207 is mounted in the delivery box 200 so that it can be carried together with the delivery box 200 at the time of carrying the delivery box 200 apart from the vehicle.

As the temperature adjustment unit 206, for example, a refrigeration cycle device, a Peltier element, or the like can be used. In the embodiment, as the temperature adjustment unit 206, a refrigeration cycle device is used. The refrigeration cycle device as a component of the temperature adjustment unit 206 has a known configuration that a compressor, a condenser, an expansion valve, and an evaporator are connected by a refrigerant pipe, and air-conditioned wind whose temperature is controlled to a set temperature can be blown to air-conditioned space in which the delivery item 201 is stored.

The temperature adjustment unit 206 performs temperature adjustment so that the delivery item 201 becomes at a predetermined temperature. The temperature of the blown air of the temperature adjustment unit 206 is set on the basis of the required temperature of the delivery item 201.

The control unit 202 can acquire operation information relating to an operation state of the temperature adjustment unit 206 from the temperature adjustment unit 206. The operation information of the temperature adjustment unit 206 includes a power consumption per unit time of the temperature adjustment unit 206, high pressure of the refrigeration cycle device, blown-air temperature, blown-air volume, a current passage state of a device to be controlled by the control unit 202, a communication state between the device to be controlled and the control unit 202, whether a self-protection function is started or not, and the like.

The power supply 207 is a battery for supplying a power to electric devices including the temperature adjustment unit 206. As the power supply 207, a secondary battery capable of repeating charging and discharging can be used. The power supply 207 is provided detachably from the delivery box 200. The suppliable power amount of the power supply 207 decreases with use. The power supply 207 can be charged while being attached to the delivery box 200 or in a state where the power supply 207 is detached from the delivery box 200. The control unit 202 can acquire power supply information of the power supply 207 from the power supply 207. The power supply information includes the suppliable power amount of the power supply 207.

As the spare power supply 208, a battery having the same configuration as that of the power supply 207 can be used. The power supply 207 can be replaced by the spare power supply 208. In the case where the power supply 207 is replaced by the spare power supply 208, the spare power supply 208 newly becomes the power supply 207. There is also a case that the spare power supply 208 is not provided for the delivery box 200.

The identification unit 209 is an interface for inputting delivery person information which specifies the delivery person of the delivery box 200, spare power supply information relating to the spare power supply 208, and the like to the control unit 202. The spare power supply information includes the presence/absence of the spare power supply 208 in the delivery box 200 and the suppliable power amount of the spare power supply 208.

The various sensors 210 include a delivery item temperature sensor of detecting the temperature of the delivery item 201, an ambient temperature sensor of detecting ambient temperature, and an open/close sensor of detecting an open/close state of the lid of the delivery box 200. The delivery item temperature sensor may detect the temperature of the delivery item 201 directly or indirectly. As the configuration of indirectly detecting the temperature of the delivery item 201, it is sufficient to detect the inside temperature of a portion in which the delivery item 201 is stored in the delivery box 200 by the delivery item temperature sensor and indirectly detect the temperature of the delivery item 201 from the inside temperature.

From the delivery box 200 to the management server 100, the delivery box information is transmitted before start of delivery of the delivery item 201 and during delivery. The delivery box information includes operation information of the temperature adjustment unit 206, position information of the delivery box 200, power supply information of the power supply 207, delivery person information relating to the delivery person, spare power supply information of the spare power supply 208, sensor information of the various sensors 210, and the like. The sensor information of the various sensors 210 includes temperature information of the delivery item 201, ambient temperature, and the like.

From the management server 100 to the delivery box 200, delivery start instruction information, power supply recovery instruction information, delivery cancellation instruction information, temperature recovery instruction information, adjustment instruction information, and the like is transmitted. The instruction information includes information of instructing the delivery person to perform a predetermined operation and information of instructing the delivery box 200 to perform a predetermined process.

The delivery start instruction information is information of instructing delivery start of the delivery item 201 by the delivery box 200 and includes information relating to the kind of the delivery item 201, information relating to required temperature of the delivery item 201, information relating to the delivery source, and information relating to the delivery destination. The power supply recovery instruction is information of instructing recovery of the power supply 207 and includes information of instructing charging of the power supply 207 and information of instructing replacement to the spare power supply 208. The delivery cancellation instruction information is information of instructing cancellation of delivery of the delivery item 201 using the delivery box 200.

The temperature recovery instruction information is information of instructing recovery of the delivery item 201 to a predetermined temperature. For example, when the temperature of the delivery item 201 rises, the temperature recovery instruction information can be information of instructing decrease in the setting temperature and increase in air volume of the temperature adjustment unit 206. In the case where the temperature of the delivery item 201 rises due to the open state of the lid of the delivery box 200, the temperature recovery instruction information can be information of instructing closure of the lid of the delivery box 200.

The adjustment instruction information includes information of instructing adjusting process of extending the temperature adjustable time in which the temperature of the delivery item 201 can be adjusted by the delivery box 200 and information of instructing adjusting process of shortening the delivery prediction time which is required for delivery of the delivery item 201 using the delivery box 200.

The adjusting process of extending the temperature adjustable time includes switching to a power-saving mode of the delivery box 200, adjustment of the setting temperature of the temperature adjustment unit 206, adjustment of air volume of the temperature adjustment unit 206, adjustment of an air blow mode of the temperature adjustment unit 206, adjustment of the air-conditioned space of the delivery box 200, replacement of the power supply 207 to the spare power supply 208, and the like. The adjusting process of shortening the delivery prediction time includes adjustment of a delivery route, and the like.

The power-saving mode of the delivery box 200 can be realized by suppressing a power consumption of devices other than the temperature adjustment unit 206 and, for example, can be realized by erasing display of the display unit 205, decreasing communication frequency of the transmission/reception unit 203, and the like. As for the adjustment of the setting temperature of the temperature adjustment unit 206, for example, it is sufficient to increase the setting temperature in the case where the setting temperature of the temperature adjustment unit 206 is low more than necessary. As for the adjustment of the air volume of the temperature adjustment unit 206, for example, it is sufficient to decrease the air volume in the case where the air volume of the temperature adjustment unit 206 is large more than necessary. As for the adjustment of the air blow mode of the temperature adjustment unit 206, for example, it is sufficient to make air blown concentratedly on the delivery item 201. As for the adjustment of the air-conditioned space of the delivery box 200, for example, in the case where the air-conditioned space of the delivery box 200 is too large for the delivery item 201, it is sufficient to make the air-conditioned space smaller by using a partition. As for the adjustment of the delivery route, in the case where there is a delivery route by which transfer time to the delivery destination 20 becomes shorter, it is sufficient to change the delivery route.

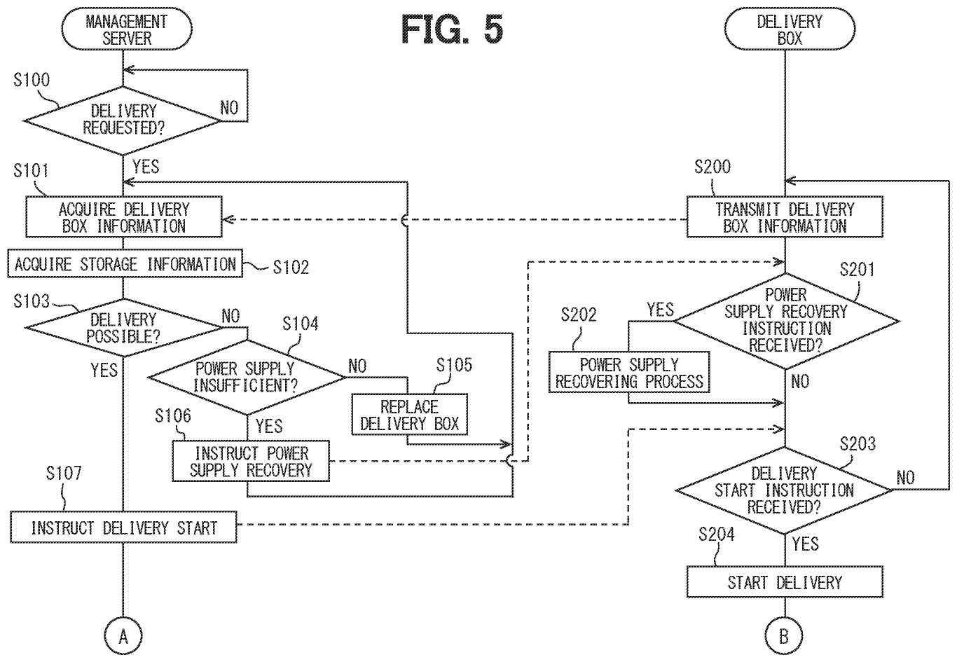

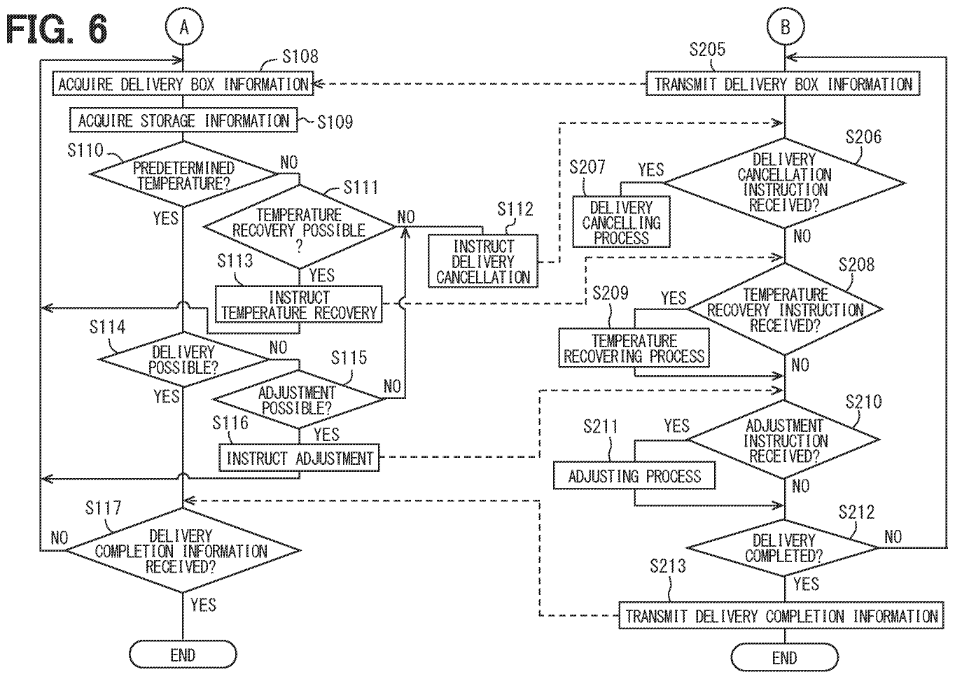

The process of delivering the delivery item 201 by the delivery system of the embodiment will be described with reference to the flowcharts of FIGS. 5 and 6. FIG. 5 indicates the flow of the delivery process before start of delivery. FIG. 6 indicates the flow of the delivery process after start of delivery.

First, the delivery process before start of delivery will be described with reference to FIG. 5. As illustrated in FIG. 5, the management server 100 determines whether there is a delivery request or not in S100. When it is determined that there is no delivery request as a result of the determining process in S100, the determining process in S100 is repeated until a delivery request is made. On the other hand, when it is determined that there is a delivery request as a result of the determining process in S100, delivery box information is acquired from the delivery box 200 in S101, and storage information is acquired from the storage unit 103 in S102.

The delivery box information is transmitted from the delivery box 200 to the management server 100 in S200. The delivery box information from the delivery box 200 to the management server 100 may be transmitted periodically or in response to a request from the management server 100. The delivery box information transmitted from the delivery box 200 to the management server 100 in S200 includes operation information of the temperature adjustment unit 206, position information of the delivery box 200, power supply information relating to the power supply 207, delivery person information relating to the delivery person, and spare power supply information relating to the spare power supply 208.

The storage information acquired by the management server 100 from the storage unit 103 in S102 includes determination criterion information, history information, delivery item information, road information, weather information, and date and time information. In each of the road information and the weather information, both real-time information and prediction information is included.

Subsequently, in S103, the management server 100 performs delivery possibility determination for determining whether delivery of the delivery item 201 by the delivery box 200 is possible or not on the basis of the delivery box information and the storage information. The delivery possibility determination in S103 is executed by the delivery possibility determination unit 101a of the management server 100.

In the delivery possibility determination in S103, when the delivery prediction time required for delivery of the delivery item 201 using the delivery box 200 is equal to or less than the temperature adjustable time in which the temperature adjustment of the delivery item 201 by the delivery box 200 is possible, it can be determined that delivery is possible. In the delivery possibility determination, it is sufficient to determine whether the suppliable power amount of the power supply 207 is enough for the delivery of the delivery item 201 using the delivery box 200. The delivery possibility determining process can be performed on the basis of the power supply information including at least the suppliable power amount of the power supply 207 of the delivery box 200.

In the delivery possibility determining process, using the information related to the operation state of the temperature adjustment unit 206 in addition to the suppliable power amount of the power supply 207, when the refrigeration cycle operation state of the temperature adjustment unit 206 lies within the reference range, a device to be controlled and the control unit 202 can communicate with each other, and an error signal (protection function starting signal) is not generated, it can be determined that delivery is possible. The information related to the operation state of the temperature adjustment unit 206 includes, for example, high pressure of the refrigeration cycle device, blown-air temperature, a current passage state of a device to be controlled, a communication state between the device to be controlled and the control unit 202, information acquired from the temperature adjustment unit 206 such as whether a self-protection function is started or not, diagnosis of the temperature adjustment unit 206 and protection information acquired from the control unit 202, and the like. Whether the refrigeration cycle operation state of the temperature adjustment unit 206 lies within the reference range or not can be determined by using the determination criterion information and the history information stored in the storage unit 103. Further, by performing the delivery possibility determining process using other information as well, a more accurate determination result can be acquired.

The delivery prediction time is acquired by the delivery prediction time acquiring unit 101b of the management server 100. The delivery prediction time can be acquired on the basis of at least the distance between the delivery box 200 and the delivery destination 20 and the transfer speed of the delivery box 200. Further, by using any of information which exerts influence on delivery prediction time such as road information, weather information, history information, and date/time information, more accurate delivery prediction time can be acquired.

The temperature adjustable time is acquired by the temperature adjustable time acquiring unit 101c of the management server 100. The temperature adjustable time can be acquired on the basis of at least the suppliable power amount of the power supply 207. It is desirable to acquire the temperature adjustable time on the basis of the suppliable power amount of the power supply 207 and, in addition, the power consumption per unit time of the temperature adjustment unit 206. Further, by using any of information which exerts influence on temperature adjustable time such as ambient temperature, operation state of the temperature adjustment unit 206 (for example, high pressure of the refrigeration cycle device and the blown-air temperature), history information of the temperature adjustment unit 206, history information of the power supply 207, and the open/close state of the lid of the delivery box 200, more accurate temperature adjustable time can be acquired.

When it is determined that delivery is not possible as a result of the determining process in S103, whether or not the power supply 207 is insufficient, that is, whether the suppliable power amount of the power supply 207 is enough to deliver the delivery item 201 is determined in S104.

As a result, when it is determined that the power supply 207 is not insufficient, presence of some failure in the delivery box 200 or the refrigeration cycle device is determined, replacement of the delivery box 200 is determined in S105, and the program returns to the process of S101. On the other hand, when it is determined that the power supply 207 is insufficient, power supply recovery instruction information is transmitted to the delivery box 200 in S106, and the program returns to the process of S101.

When it is determined in S201 that the power supply recovery instruction information is received, the delivery box 200 performs the power supply recovering process in S202. Simultaneously, shortage of the power supply may be notified to the delivery person by a display device such as a display lamp provided for the delivery box 200 or the power supply 207, or may be displayed on the screen of a portable terminal. The power supply recovering process can be performed by charging the power supply 207 from an external power supply or replacement of the power supply 207 to the spare power supply 208. The power supply 207 may be in a state where it is attached to the delivery box 200. Alternately, in a state before attachment, a plurality of power supplies 207 are prepared in the delivery source 10, and the power supply 207 may be replaced to another power supply 207. In this case, the power supply 207 which is to be mounted in the delivery box 200 is set in advance, and the above-described determination is executed.

When it is determined that delivery is possible in the determining process of S103, the management server transmits the delivery start instruction information to the delivery box 200 in S107. The delivery start instruction information includes information relating to the kind of the delivery item 201, required temperature, a delivery source, a delivery destination, and a delivery route.

When it is determined in S203 that the delivery start instruction information is received, the delivery box 200 performs the delivery starting process in S204. The delivery starting process can be performed by storing the delivery item 201 into the delivery box 200 by the delivery person in the delivery source 10 and starting travel toward the delivery destination 20. In the delivery box 200, the temperature adjustment by the temperature adjustment unit 206 is performed so as to maintain the delivery item 201 at a predetermined temperature.

Subsequently, the process after start of delivery will be described with reference to FIG. 6.

There is a possibility that unexpected contingency which exerts influence on delivery of the delivery item 201 occurs after starting the delivery of the delivery item 201 by the delivery box 200 in S204. The unexpected contingency which occurs after start of delivery includes, for example, a change in the operation state of the temperature adjustment unit 206, a change in the road information, a change in the weather information, frequent opening/closing of the lid of the delivery item 201, improper handling of the delivery item 201 by the delivery person, loss in roads of the delivery person, negligence of the delivery person, and the like. A change in the road information includes, for example, occurrence of new traffic jam, traffic regulation, and the like. A change in the weather information includes, for example, rise of the ambient temperature, deterioration in weather, and the like.

Consequently, also after start of delivery, the management server 100 of the embodiment performs the delivery possibility determination for determining whether delivery of the delivery item 201 using the delivery box 200 is possible or not. The delivery possibility determination includes delivery item temperature determination of determining whether the delivery item 201 maintains proper temperature or not.

As illustrated in FIG. 6, the management server 100 acquires delivery box information from the delivery box 200 in S108 and acquires storage information from the storage unit 103 in S109.

The delivery box information is transmitted from the delivery box 200 to the management server 100 in S205. The delivery box information may be transmitted from the delivery box 200 to the management server 100 either periodically or in response to a request from the management server 100. The delivery box information transmitted from the delivery box 200 to the management server 100 in S205 includes delivery item temperature information relating to temperature of the delivery item 201, ambient temperature information relating to ambient temperature, operation information of the temperature adjustment unit 206, position information of the delivery box 200, power supply information relating to the power supply 207, and spare power supply information relating to the spare power supply 208.

The storage information acquired from the storage unit 103 by the management server 100 in S109 includes history information, road information, and weather information. Each of the road information and the weather information includes both real-time information and prediction information.

Subsequently, the management server 100 performs the delivery item temperature determination of determining whether or not the temperature of the delivery item 201 is the predetermined temperature in S110. The delivery item temperature determination is made as a part of the delivery possibility determination. For example, there is a case that when the temperature of the delivery item 201 rises after start of delivery, it is determined in S110 that the temperature of the delivery item 201 is not the predetermined temperature. There is the possibility that the temperature rise of the delivery item 201 occurs, for example, when a situation such as rise in ambient temperature, frequent opening/closing of the lid of the delivery box 200, or abnormal operation of the temperature adjustment unit 206 arises.

When it is determined that the temperature of the delivery item 201 is not the predetermined temperature as a result of the determining process of S110, whether temperature recovery of the delivery item 201 is possible or not is determined in S111. In S111, it is sufficient to determine whether the delivery item 201 can be recovered to the predetermined temperature by adjustment of the temperature adjustment unit 206 or the like.

As a result, when it is determined that the temperature recovery of the delivery item 201 is not possible, delivery cancellation instruction information is transmitted from the management server 100 to the delivery box 200 in S112. When it is determined that the delivery cancellation information is received in S206, the delivery box 200 performs delivery cancelling process of cancelling delivery of the delivery item 201 using the delivery box 200 in S207. In the delivery cancelling process, the delivery person may move the delivery box 200 in which the delivery item 201 is stored to the delivery source 10.

When it is determined that the temperature of the delivery item 201 can be recovered as a result of the determining process of S111, the temperature recovery instruction information is transmitted from the management server 100 to the delivery box 200 in S113, and the program returns to the process of S108. When it is determined that the temperature recovery instruction information is received in S208, the delivery box 200 performs the temperature recovering process of recovering the delivery item 201 to the predetermined temperature in S209. In the temperature recovering process, processes such as decrease in the blown-air temperature or increase in the air volume of the temperature adjustment unit 206 or, in the case where the lid of the delivery box 200 is open, closure of the lid can be performed.

When it is determined that the delivery item 201 is at the predetermined temperature as a result of the determining process in S110, in S114, the management server 100 performs delivery possibility determination of determining whether delivery of the delivery item 201 by the delivery box 200 is possible or not on the basis of the delivery box information and the storage information.

In S114, process similar to that in the above-described S103 can be performed. Specifically, when the delivery prediction time required to deliver the delivery item 201 by using the delivery box 200 is equal to or less than the temperature adjustable time in which the temperature adjustment of the delivery item 201 by the delivery box 200 is possible, it can be determined that delivery is possible.

In the delivery possibility determination in S114, the delivery possibility determining process can be performed on the basis of at least the suppliable power amount of the power supply 207 of the delivery box 200. By performing the delivery possibility determining process using other information in addition to the suppliable power amount of the power supply 207, a more accurate determination result can be acquired.

When it is determined that delivery of the delivery item 201 is not possible as a result of the determining process in S114, in S115, whether or not delivery of the delivery item 201 using the delivery box 200 becomes possible by adjusting at least one of the temperature adjustable time and the delivery prediction time is determined. The adjustment of the temperature adjustable time is a process for extending the temperature adjustable time, and the adjustment of the delivery prediction time is a process for shortening the delivery prediction time.

The adjusting process of extending the temperature adjustable time includes switching to the power-saving mode of the delivery box 200, adjustment of the setting temperature of the temperature adjustment unit 206, adjustment of air volume of the temperature adjustment unit 206, adjustment of the air blow mode of the temperature adjustment unit 206, adjustment of the air-conditioned space in the delivery box 200, and replacement of the power supply 207 to the spare power supply 208. The adjusting process of shortening the delivery prediction time includes adjustment of the delivery route.

When it is determined that delivery does not become possible by adjustment of any of the temperature adjustable time and the delivery prediction time as a result of the determining process of S115, the delivery cancellation instruction information is transmitted from the management server 100 to the delivery box 200 in S112. When it is determined in S206 that the delivery cancellation information is received, the delivery box 200 performs delivery cancelling process of cancelling delivery of the delivery item 201 using the delivery box 200 in S207.

On the other hand, when it is determined that delivery becomes possible by adjustment of at least one of the temperature adjustable time and the delivery prediction time as a result of the determining process of S115, adjustment instruction information is transmitted from the management server 100 to the delivery box 200 in S116, and the program returns to the process of S108. When it is determined in S210 that the adjustment instruction information is received, the delivery box 200 performs adjusting process on the basis of the adjustment instruction information in S211.

Subsequently, the delivery box 200 determines whether delivery of the delivery item 201 is completed or not in S212. When it is determined that delivery of the delivery item 201 has not been completed as a result, the program returns to the process of S205 and repeatedly performs the processes of S205 to S212 until delivery of the delivery item 201 is completed. On the other hand, when it is determined that delivery of the delivery item 201 is completed, delivery completion information indicating that delivery of the delivery item 201 is completed is transmitted from the delivery box 200 to the management server 100 in S213, and the process of delivering the delivery item 201 is finished. With the completion of the process of delivering the delivery item 201, the power supply 207 of the delivery box 200 is turned off.

When it is determined in S117 that the delivery completion information is not received, the management server 100 returns to the process of S108 and repeatedly performs the processes of S108 to S117 until the delivery completion information is received. On the other hand, when it is determined in S117 that the delivery completion information is received, the management server 100 finishes the process of delivering the delivery item 201.

According to the above-described embodiment, the delivery possibility determining process is performed on the basis of at least the suppliable power amount of the power supply 207 of the delivery box 200. Consequently, delivery according to the suppliable power amount of the power supply 207 can be performed, the delivery item 201 can be maintained at predetermined temperature until completion of delivery, and the quality of the delivery item 201 can be maintained. Therefore, without necessity of providing the delivery box 200 with the power supply 207 of large amount, both maintenance of the quality of the delivery item 201 until completion of delivery and delivery efficiency of the delivery item 201 can be realized.

In the embodiment, also after start of delivery, the management server 100 always collects the delivery box information from the delivery box 200 and the storage information from the storage unit 103 and performs the delivery possibility determination. Consequently, even in the case where a situation which exerts influence on the maintenance of the temperature of the delivery item 201 occurs after start of delivery, the situation can be grasped early, and a handling such as a temperature recovery instruction, a delivery cancellation instruction, or an adjustment instruction can be performed. Even when inconvenience such as erroneous operation, malfunction, or a failure occurs in the delivery box 200, the quality deterioration of the delivery item 201 caused by the inconvenience can be suppressed.

By performing the delivery possibility determining process by using the suppliable power amount of the power supply 207 and, in addition, other information, the management server 100 can acquire a more accurate determination result. For the delivery possibility determining process, for example, road information, weather information, history information, ambient temperature, the operation state of the temperature adjustment unit 206, the open/close state of the lid of the delivery box 200, date and time information, and the like can be used.

In the embodiment, the management server 100 performs the delivery possibility determination on the basis of the delivery box information and the storage information. Consequently, the process load on the delivery box 200 which performs the temperature adjustment of the delivery item 201 can be lessened.

### Second Embodiment

Next, a second embodiment of the present disclosure will be described. Hereinafter, only parts different from the foregoing first embodiment will be described.

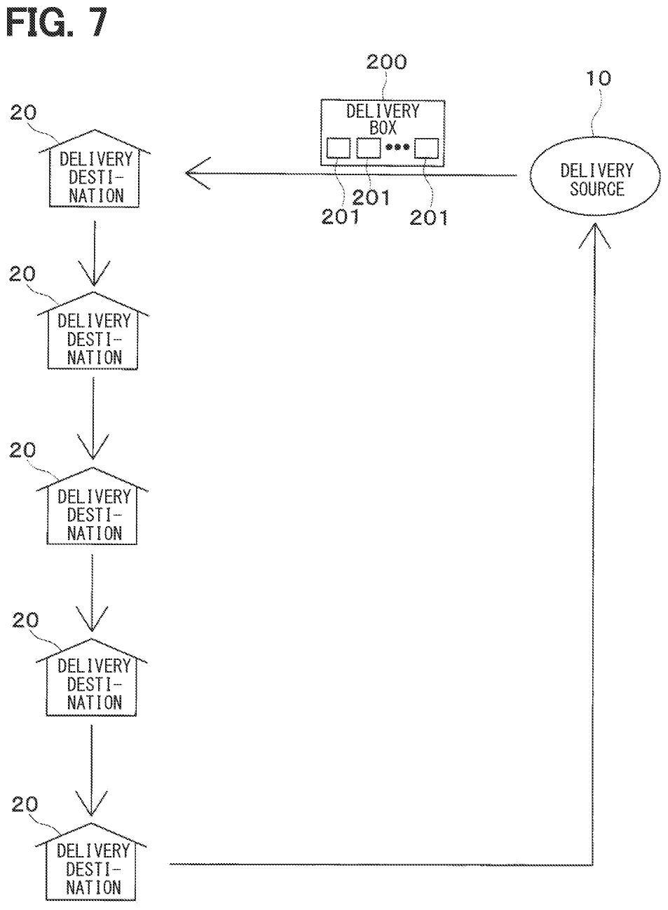

As illustrated in FIG. 7, in the second embodiment, a plurality of delivery items 201 are stored in the delivery box 200 in the delivery source 10 and successively delivered to a plurality of delivery destinations 20. The plurality of delivery items 201 may be of the same kind or different kinds. In the second embodiment, the delivery order to the plurality of delivery destinations 20 is determined at the delivery start time, and the plurality of delivery items 201 are delivered in a planned manner.

In the delivery possibility determination of the second embodiment, whether or not a plurality of delivery items 201 can be delivered to respective delivery destinations 20 by using the delivery box 200 is determined. On the basis of the delivery box information acquired from the delivery box 200 and the storage information acquired from the storage unit 103, the management server 100 performs minimalization of the power consumption of the temperature adjustment unit 206 and maximization of the number of delivery times of the delivery items 201 in the case of performing delivery a plurality of times. Concretely, optimization of the delivery route, optimization of control of the temperature adjustment unit 206, optimization of control of the power supply 207, determination of the optimum timing of replacement to the spare power supply 208, and the like are performed.

In the above-described second embodiment, in the delivery possibility determination, whether the plurality of delivery items 201 can be delivered to the respective delivery destinations 20 or not is determined. Consequently, the plurality of delivery items 201 can be efficiently delivered according to the suppliable power amount of the power supply 207. Therefore, until completion of delivery of each of the plurality of delivery items 201, the temperature can be maintained at the predetermined temperature, and the quality of each of the plurality of delivery items 201 can be maintained.

### Third Embodiment

Next, a third embodiment of the present disclosure will be described. Hereinafter, only parts different from the foregoing embodiments will be described.

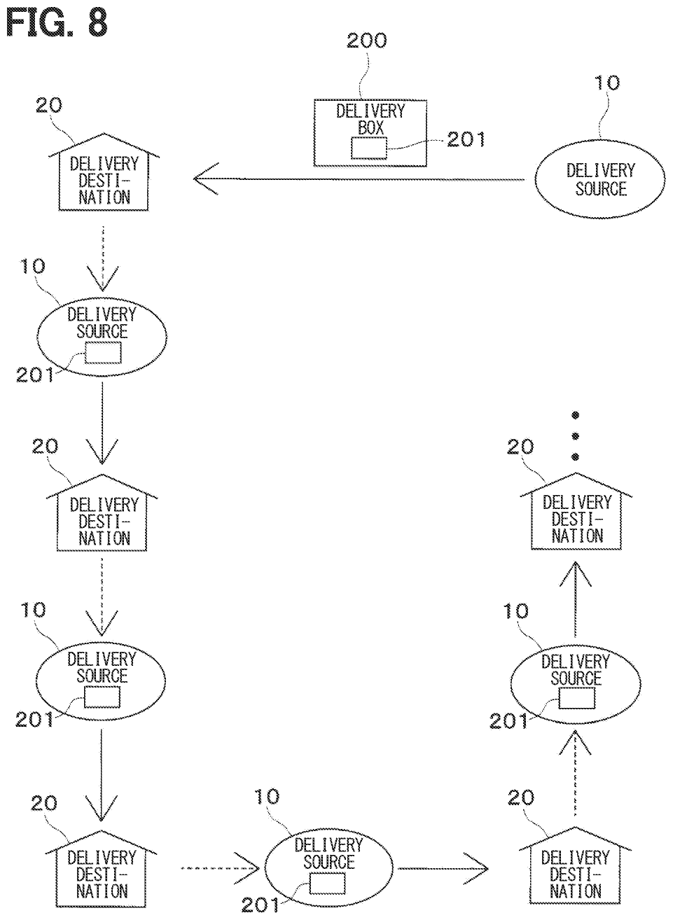

As illustrated in FIG. 8, in the third embodiment, delivery requests are made from a plurality of delivery requesters, and delivery of a delivery item 201 from a delivery source 10 to a delivery destination 20 is performed a plurality of times. The plurality of deliveries are independent from one another and performed successively.

The management server 100 performs the delivery possibility determination on the basis of the delivery request information from a delivery requester for the delivery box 200 which finished delivery of the delivery item 201. After completion of delivery of the delivery item 201, the delivery box 200 receives new delivery start instruction information from the management server 100. The delivery person stores a delivery item 201 in the delivery box 200 in the next delivery source 10 on the basis of the new delivery start instruction information and starts new delivery.

In the above-described third embodiment, the delivery possibility determination is made each time delivery of once is finished, and a plurality of deliveries are performed successively. Consequently, each of unpredicted delivery requests from a plurality of delivery requesters can be handled and, while maintaining the quality of a plurality of delivery items 201, efficient delivery can be performed.

### Fourth Embodiment

Next, a fourth embodiment of the present disclosure will be described. Hereinafter, only parts different from the foregoing embodiments will be described.

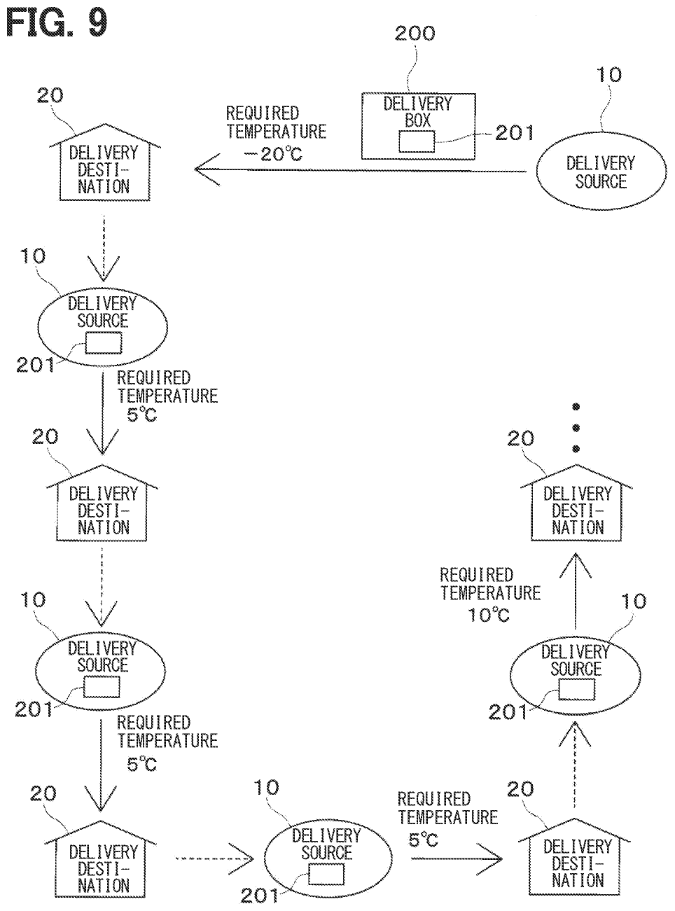

As illustrated in FIG. 9, in the fourth embodiment, in a manner similar to the third embodiment, delivery requests are made from a plurality of delivery requesters, and delivery of the delivery item 201 from the delivery source 10 to the delivery destination 20 is performed a plurality of times.

A plurality of delivery items 201 include delivery items 201 whose required temperatures are different. FIG. 9 illustrates an example of delivery of five delivery items 201, and the required temperatures of the delivery items 201 are −20° C., 5° C., ° C., 5° C., and 10° C.

In the fourth embodiment, delivery possibility determination of the plurality of delivery items 201 is performed on the basis of a plurality of delivery requests before delivery start, and the delivery order of the plurality of delivery items 201 is determined on the basis of required temperatures of the plurality of delivery items 201. Concretely, the delivery order of the delivery item 201 whose required temperature is low becomes the first, and the delivery order of the delivery item 201 whose required temperature is high becomes later. In the case where the delivery distance becomes longer in the delivery order based on the required temperatures of the delivery items 201 and the delivery efficiency deteriorates, the delivery order may be determined by placing priority on the delivery distance over the required temperatures of the delivery items 201.

According to the above-described fourth embodiment, by determining the delivery order of the delivery items 201 on the basis of the required temperatures of the plurality of delivery items 201, the adjustment width of the setting temperature of the temperature adjustment unit 206 is minimized, and the temperature fluctuation of the air-conditioned space in the delivery box 200 can be minimized. Consequently, while maintaining the quality of the plurality of delivery items 201, efficient delivery can be performed.

### Fifth Embodiment

Subsequently, a fifth embodiment of the present disclosure will be described. Hereinafter, only parts different from the foregoing embodiments will be described.

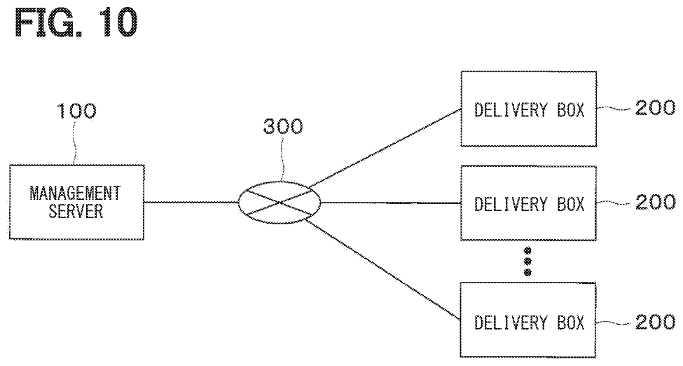

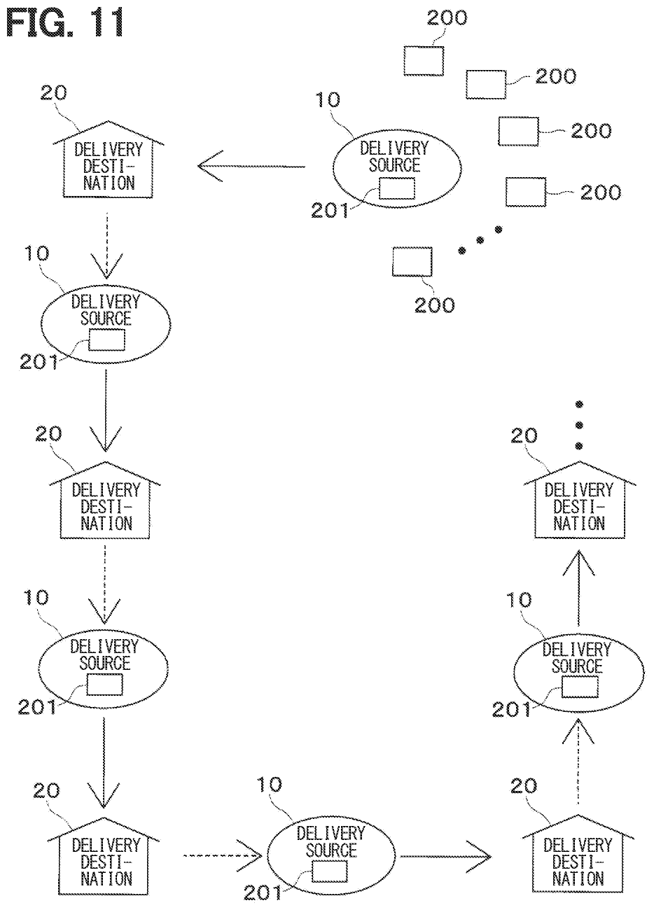

As illustrated in FIGS. 10 and 11, in the delivery system of the fifth embodiment, a plurality of delivery boxes 200 are provided. As illustrated in FIG. 11, in the fifth embodiment, different delivery requests are made from a plurality of delivery requesters, and delivery of the delivery items 201 is performed a plurality of times.

The management server 100 of the fifth embodiment acquires delivery box information from the plurality of delivery boxes 200, and performs the delivery possibility determination on each of the delivery boxes 200. The management server 100 selects a specific delivery box 200 from the plurality of delivery boxes 200 on the basis of the result of the delivery possibility determination and transmits the delivery start instruction information to the selected delivery box 200.

Selection of the delivery box 200 by the management server 100 can be performed on the basis of the distance from the delivery box 200 to the delivery source the suppliable power of the power supply 207, the operation history of the temperature adjustment unit 206, the delivery history of the delivery person, and the like. In the selection of the delivery box 200 by the management server 100, the delivery cost can be also minimized on the basis of workforce cost of the delivery person, the operation cost of the delivery box 200, and the like.

In the delivery system having a plurality of delivery boxes 200, it is desirable to efficiently use the suppliable power amount of the power supplies 207 of the plurality of delivery boxes 200. Concretely, it is desirable that the suppliable power amounts of the power supplies 207 of the plurality of delivery boxes 200 are consumed as uniformly as possible.

According to the above-described fifth embodiment, by performing the delivery management of a plurality of delivery boxes 200 by the management server 100, the optimum delivery box 200 can be selected from a plurality of delivery boxes 200 in response to delivery requests from the plurality of delivery requesters. Consequently, while maintaining the quality of a plurality of delivery items 201, efficient delivery using a plurality of delivery boxes 200 can be performed.

### Sixth Embodiment

Next, a sixth embodiment of the present disclosure will be described. Hereinafter, only parts different from the foregoing embodiments will be described.

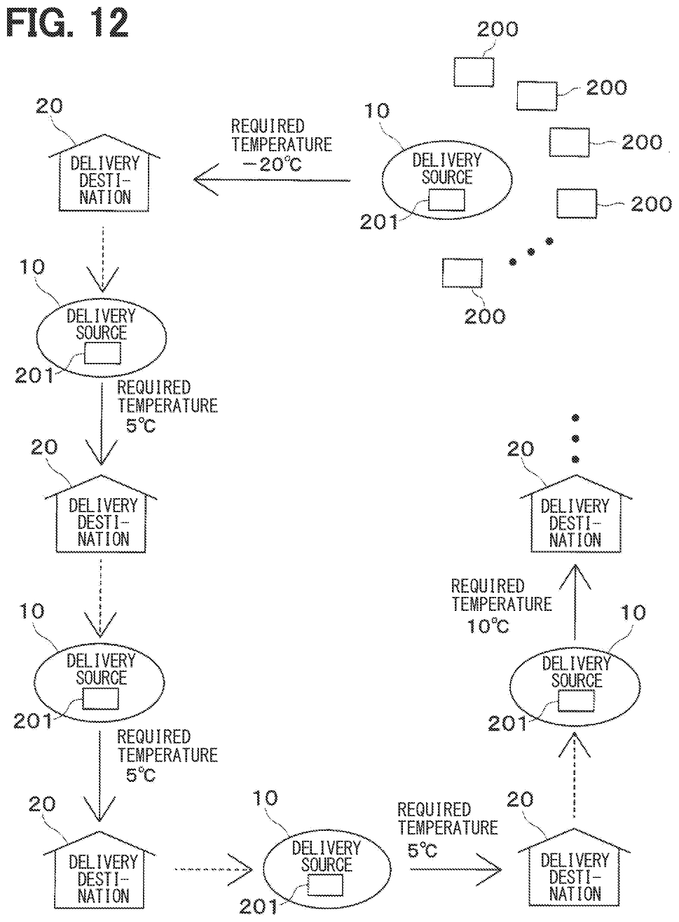

As illustrated in FIG. 12, in a delivery system of the sixth embodiment, in a manner similar to the fifth embodiment, a plurality of delivery boxes 200 are provided. Different delivery requests are sent from a plurality of delivery requesters, and delivery of the delivery items 201 is performed a plurality of times. The plurality of delivery items 201 include delivery items 201 whose required temperatures are different.

The management server 100 of the sixth embodiment acquires delivery box information from a plurality of delivery boxes 200 and performs the delivery possibility determination for each of the delivery boxes 200. In the delivery possibility determination of the sixth embodiment, whether delivery of a plurality of delivery items 201 is possible or not is determined on the basis of a plurality of delivery requests.

The management server 100 selects a specific delivery box 200 from the plurality of delivery boxes 200 on the basis of a result of the delivery possibility determination and determines the delivery order of the delivery items 201 on the basis of required temperatures of the plurality of delivery items 201.

According to the above-described sixth embodiment, by performing the delivery management of the plurality of delivery boxes 200 by the management server 100, the optimum delivery box 200 can be selected from the plurality of delivery boxes 200 for delivery requests from the plurality of delivery requesters. Further, by determining the delivery order of the delivery items 201 on the basis of the required temperatures of the plurality of delivery items 201, the adjustment width of the setting temperature of the temperature adjustment unit 206 can be minimized, and the temperature fluctuation of the air-conditioned space in the delivery box 200 can be minimized. By the above, while maintaining the quality of the plurality of delivery items 201, efficient delivery can be performed.

### Seventh Embodiment

Next, a seventh embodiment of the present disclosure will be described. Hereinafter, only parts different from the foregoing embodiments will be described.

In the seventh embodiment, a portable terminal 250 of a delivery person replaces a part of the functions of the delivery box 200. A part of the functions of the delivery box 200 replaced by the portable terminal 250 is, for example, the function of connecting communication to the communication network 300, the position specifying function, the display function, and the like. The function of connecting communication to the communication network 300 can be said as a function of communication with the management server 100. The portable terminal 250 replacing a part of the functions of the delivery box 200 is a part of the delivery box 200.

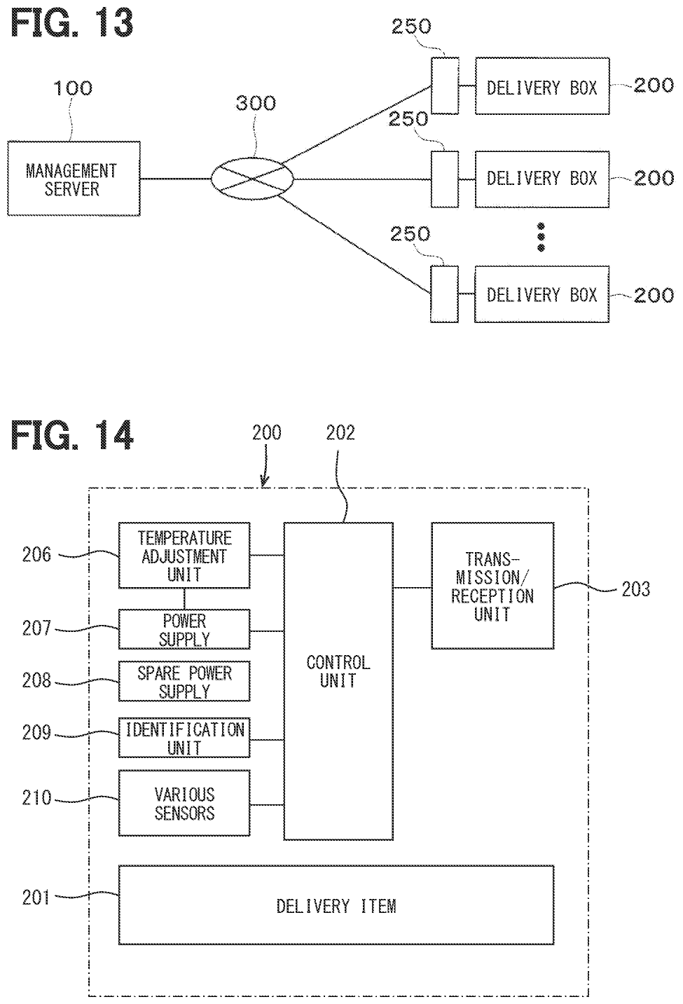

As illustrated in FIG. 13, in the seventh embodiment, the delivery box 200 and the portable terminal 250 are communication-connected in a wired or wireless manner. The portable terminal 250 is connected to the communication network 300 wirelessly. The portable terminal 250 can communicate with the management server 100 via the communication network 300. The delivery box 200 is connected to the communication network 300 via the portable terminal 250.

As illustrated in FIG. 14, the delivery box 200 of the seventh embodiment is not provided with the position specification unit 204 and the display unit 205. The transmission/reception unit 203 of the delivery box 200 has a function of near-field communication with the portable terminal 250, and is indirectly connected to the communication network 300 via the portable terminal 250.

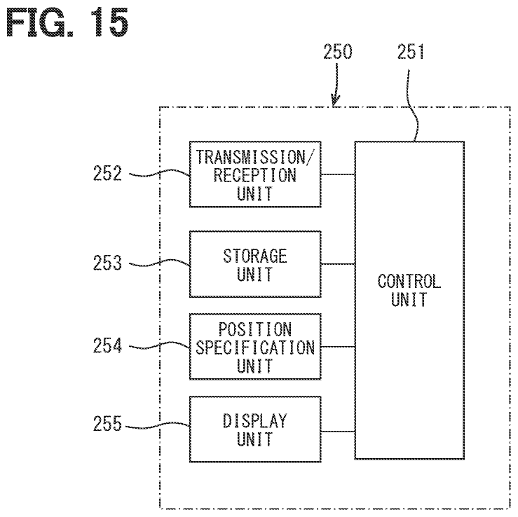

As illustrated in FIG. 15, the portable terminal 250 has a control unit 251, a transmission/reception unit 252, a storage unit 253, a position specification unit 254, and a display unit 255. As the portable terminal 250, an arbitrary portable device having those components can be used and, for example, a smartphone can be suitably used.

The control unit 251 is configured by a known microcomputer including a CPU, a ROM, and a RAM and its peripheral circuits. The control unit 251 performs various computations and processes on the basis of a control program stored in the ROM and controls operations of various devices to be controlled. In the seventh embodiment, the control unit 251 of the portable terminal 250 can perform the delivery possibility determination of determining whether delivery of the delivery item 201 by the delivery box 200 is possible or not.

The transmission/reception unit 252 has the function of connecting to the delivery box 200 in a wired or wireless manner and performing near-field communication and a network connection function of wirelessly connecting to the communication network 300. The transmission/reception unit 252 can be wirelessly connected to the communication network 300 by using, for example, a cell-phone line. The transmission/reception unit 252 includes a transmission unit of transmitting data to the outside and a reception unit of receiving data from the outside.

The storage unit 253 is a writable/readable nonvolatile storage medium (for example, a management disk, a flash memory, or the like). The storage unit 253 stores a delivery application as dedicated software for using the portable terminal 250 in the process of delivering the delivery item 201. The delivery application is started by operation of the delivery person.

The position specification unit 254 is a device for specifying the present position of the portable terminal 250 and, for example, a GPS can be used. Since the portable terminal 250 is carried by the delivery person who delivers the delivery box 200, the present position specified by the position specification unit 254 of the portable terminal 250 can be set as the present position of the delivery box 200.

The display unit 255 can display various information. The display unit 255 may have the function as an input part to which data can be entered by the delivery person as a touch panel which can be operated by the delivery person.

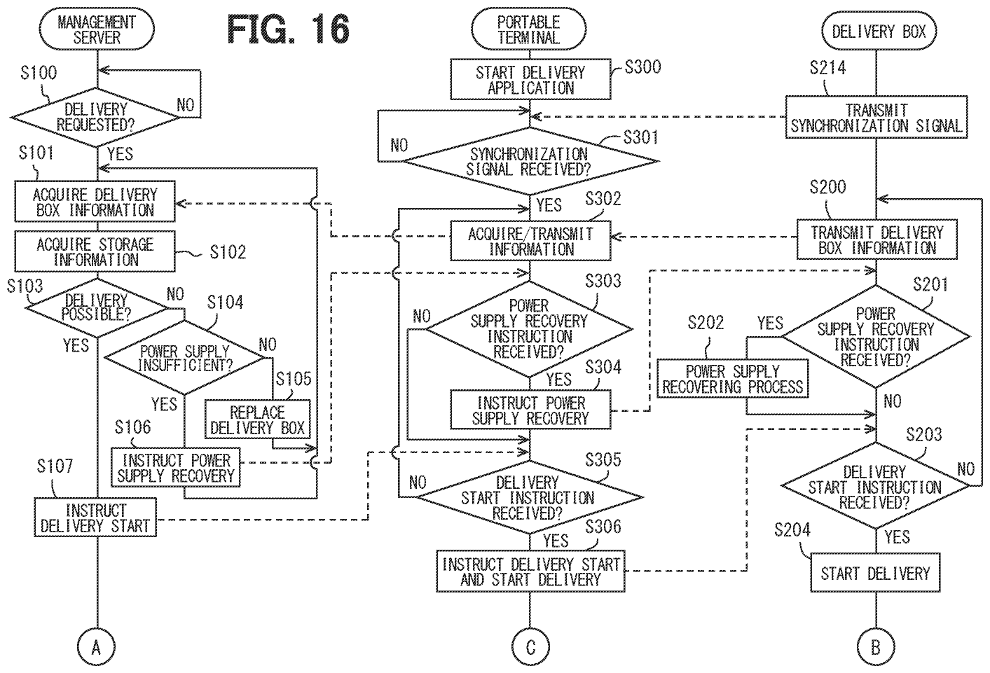

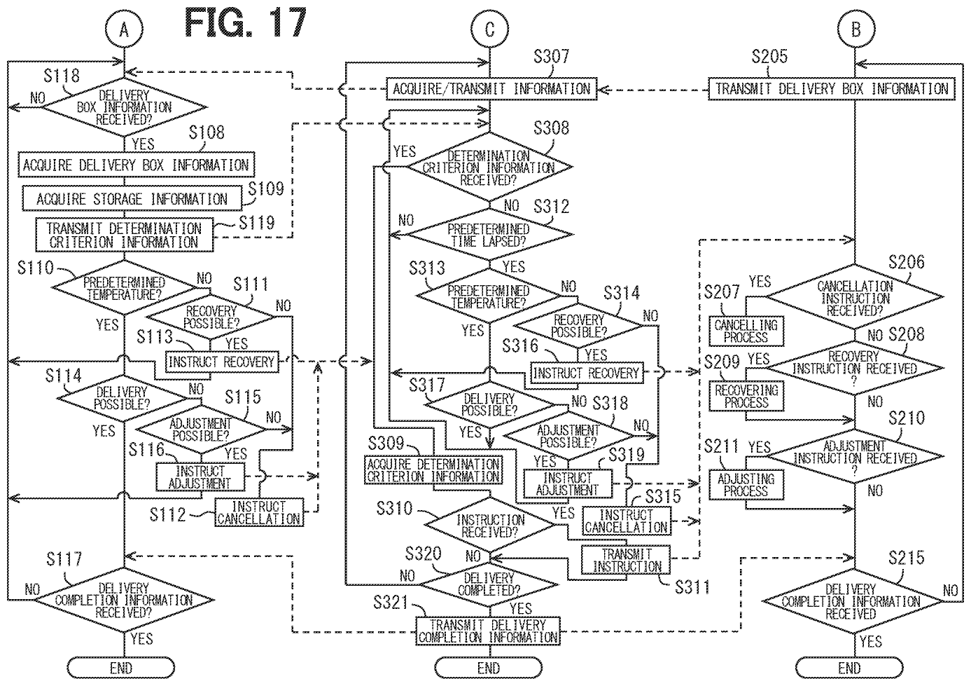

Next, the process of delivering the delivery item 201 by the delivery system of the seventh embodiment will be described by using flowcharts of FIGS. 16 and 17. FIG. 16 indicates the flow of the delivery process before start of delivery. FIG. 17 indicates the flow of the delivery process after start of delivery. FIG. 16 corresponds to FIG. 5 of the first embodiment, and FIG. 17 corresponds to FIG. 6 of the first embodiment. In FIGS. 16 and 17, processes designated by the same reference numerals as those of FIGS. 5 and 6 are the same processes as those of FIGS. 5 and 6.

First, the delivery process before start of delivery will be described by using FIG. 16.

The management server 100 determines whether there is a delivery request or not in S100. When it is determined that there is no delivery request in the determining process of S100, the program waits until a delivery request is made. When it is determined that there is a delivery request in the determining process of S100, a process of acquiring the delivery box information is performed in S101.

In the portable terminal 250, a delivery application is started by operation of the delivery person in S300. Subsequently, a synchronization signal is transmitted from the delivery box 200 to the portable terminal 250 in S214. For example, by providing the delivery box 200 with a synchronization switch and operating the synchronization switch of the delivery box 200 by the delivery person, a synchronization signal can be transmitted from the delivery box 200 to the portable terminal 250.

The portable terminal 250 determines whether a synchronization signal from the delivery box 200 is received or not and waits until the synchronization signal is received in S301. When it is determined in the determining process of S301 that the portable terminal 250 receives the synchronization signal from the delivery box 200, the communication connection between the portable terminal 250 and the delivery box 200 is completed. At this time, a connection completion signal may be transmitted from the portable terminal 250 to the delivery box 200.

The delivery box 200 whose connection to the portable terminal 250 is completed transmits the delivery box information to the portable terminal 250 in S200. The portable terminal 250 acquires the delivery box information transmitted from the delivery box 200 and transmits it to the management server 100 in S302.

The management server 100 acquires the delivery box information transmitted from the portable terminal 250 in S101, and acquires the storage information from the storage unit 103 in S102.

Subsequently, in S103, the management server 100 performs the delivery possibility determination of determining whether delivery of the delivery item 201 by the delivery box 200 is possible or not on the basis of the delivery box information and the storage information.

When it is determined that the delivery is not possible in the determining process of S103, in S104, whether the power supply 207 is insufficient or not, that is, whether or not the suppliable power amount of the power supply 207 is sufficient to deliver the delivery item 201 is determined.

When it is determined that the power supply 207 is not insufficient in the determining process of S104, replacement of the delivery box 200 is determined in S105, and the program returns to the process of S101. When it is determined that the power supply 207 is insufficient in the determining process of S104, power supply recovery instruction information is transmitted to the portable terminal 250 in S106, and the program returns to the process of S101.

When it is determined in the determining process of S303 that the power supply recovery instruction information is received, the portable terminal 250 transmits the power supply recovery instruction information to the delivery box 200 in S304. When it is determined in the determining process of S201 that the power supply recovery instruction information is received, the delivery box 200 performs the power supply recovering process in S202.

When it is determined in the determining process of S103 that the delivery is possible, the management server transmits delivery start instruction information to the portable terminal 250 in S107.

When it is determined in the determining process of S305 that delivery start instruction information is received, the portable terminal 250 transmits the delivery start instruction information to the delivery box 200 and performs the delivery starting process in S306. When it is determined in the determining process of S305 that the delivery start instruction information is not received, the portable terminal 250 returns to the process of S302.

When it is determined in the determining process of S203 that the delivery start instruction information is received, the delivery box 200 performs the delivery starting process in S204. When it is determined in the determining process of S203 that the delivery start instruction information is not received, the delivery box 200 returns to the process of S200.

Next, the process after start of delivery will be described by using FIG. 17.

In S205, the delivery box 200 transmits the delivery box information to the portable terminal 250. In S307, the portable terminal 250 acquires the delivery box information transmitted from the delivery box 200 in S302, and transmits it to the management server 100.

The management server 100 determines whether or not the delivery box information is received in S118 and waits until the delivery box information is received.

In the case where the portable terminal 250 is positioned in a place where the number of base stations of cell-phone companies is small like a mountain area, there is the possibility that the portable terminal 250 cannot be connected to the communication network 300, and a communication failure occurs between the management server 100 and the portable terminal 250. When such a communication failure occurs, the management server 100 cannot receive the delivery box information from the portable terminal 250. Consequently, in S118, when the management server 100 cannot receive the delivery box information from the portable terminal 250, the management server 100 determines that a communication failure with the portable terminal 250 occurs and enters a standby mode until the delivery box information is received.

When it is determined in the determining process of S118 that the delivery box information is received, the management server 100 acquires the delivery box information from the portable terminal 250 in S108, and acquires storage information from the storage unit 103 in S109.

Subsequently, in S119, the management server 100 transmits determination criterion information to the portable terminal 250. The determination criterion information is information included in the storage information and information as a criterion of delivery possibility determination of determining whether delivery of the delivery item 201 by the delivery box 200 is possible or not. The determination criterion information can include a mathematical expression for determining whether delivery is possible or not using, as variables, various information included in the delivery box information and various information included in the storage information. Since the various information included in the storage information changes with the lapse of time, latest information is transmitted from the management server 100 to the portable terminal 250 in S119.

The portable terminal 250 determines whether the determination criterion information is received or not in S308. When it is determined in the determining process of S308 that the determination criterion information is received, the portable terminal 250 acquires the determination criterion information in S309. At this time, the portable terminal 250 starts a timer and starts measuring lapse time since the determination criterion information is received. The timer is reset each time the portable terminal 250 receives the determination criterion information.

After transmitting the determination criterion information in S119, the management server 100 performs delivery item temperature determination of determining whether the temperature of the delivery item 201 is predetermined temperature or not in S110. When it is determined in the determining process of S110 that the delivery item 201 is not at the predetermined temperature, whether recovery of the temperature of the delivery item 201 is possible or not is determined in S111.

When it is determined that the temperature recovery of the delivery item 201 is not possible in the determining process of S111, delivery cancellation instruction information is transmitted from the management server 100 to the portable terminal 250 in S112. When it is determined that recovery of the temperature of the delivery item 201 is possible in the determining process of S111, temperature recovery instruction information is transmitted from the management server 100 to the portable terminal 250 in S113, and the program returns to the process of S118.

When it is determined that the delivery item 201 is at the predetermined temperature in the determining process of S110, in S114, the management server 100 performs delivery possibility determination of determining whether delivery of the delivery item 201 by the delivery box 200 is possible or not on the basis of the delivery box information and the storage information.

When it is determined in the determining process of S114 that delivery of the delivery item 201 is not possible, in S115, whether or not delivery of the delivery item 201 using the delivery box 200 becomes possible by adjustment of at least one of the temperature adjustable time and the delivery prediction time is determined.

When it is determined in the determining process of S115 that delivery does not become possible by even the adjustment of the temperature adjustable time and the delivery prediction time, delivery cancellation instruction information is transmitted from the management server 100 to the portable terminal 250 in S112.

When it is determined in the determining process of S115 that delivery becomes possible by the adjustment of at least one of the temperature adjustable time and the delivery prediction time, the adjustment instruction information is transmitted from the management server 100 to the portable terminal 250 in S116, and the program returns to the process of S118.

The portable terminal 250 determines whether or not instruction information of any of recovery instruction information, adjustment instruction information, and cancellation instruction information is received from the management server 100 in S310. When it is determined that the instruction information is received in S310, the portable terminal 250 transmits the received instruction information to the delivery box 200 in S311.

When it is determined in the determining process of S206 that the delivery cancellation information is received, the delivery box 200 performs delivery cancelling process of cancelling delivery of the delivery item 201 using the delivery box 200 in S207. When it is determined that the temperature recovery instruction information is received in S208, the delivery box 200 performs temperature recovering process of recovering the delivery item 201 to the predetermined temperature in S209. When it is determined in the determining process of S210 that the adjustment instruction information is received, the delivery box 200 performs adjusting process on the basis of the adjustment instruction information in S211.

Subsequently, when it is determined that the portable terminal 250 does not receive the determination criterion information in S308, in S312, whether or not predetermined time has lapsed since the determination criterion information was received last time is determined. In S312, the determination is made by using the timer which starts measuring in S309. The “predetermined time” in S312 is time for determining occurrence of a communication failure between the management server 100 and the portable terminal 250. The predetermined time can be set to an arbitrary value and can be set to, for example, 10 minutes.

When it is determined in the determining process of S312 that the predetermined time has not lapsed, the program returns to the process of S308. When it is determined in the determining process of S312 that the predetermined time has lapsed, it can be determined that a communication failure occurs between the management server 100 and the portable terminal 250. In the portable terminal 250, in the case where the transmission/reception unit 252 cannot receive a result of delivery possibility determination from the management server 100 due to the occurrence of the communication failure, the control unit 251 executes the delivery possibility determination.

The portable terminal 250 executes the delivery possibility determination by using the determination criterion information acquired from the management server 100 and the delivery box information in S309. In the delivery possibility determination executed by the portable terminal 250, history information and the like stored in the storage unit 103 of the management server 100 cannot be used. Consequently, information which can be used in the delivery possibility determination executed by the portable terminal 250 is smaller than that in the delivery possibility determination executed by the management server 100. In this case, the number of variables which can be used in the mathematical expression included in the determination criterion information decreases. That is, it can be said that the delivery possibility determination executed by the portable terminal 250 is simpler as compared with the delivery possibility determination executed by the management server 100.

The portable terminal 250 performs delivery item temperature determination for determining whether the temperature of the delivery item 201 is predetermined temperature or not in S313. When it is determined in the determining process of S313 that the delivery item 201 is not at the predetermined temperature, whether recovery of the temperature of the delivery item 201 is possible or not is determined in S314.

When it is determined in the determining process of S314 that temperature recovery of the delivery item 201 is not possible, delivery cancellation instruction information is transmitted from the portable terminal 250 to the delivery box 200 in S315. When it is determined in the determining process of S314 that the temperature recovery of the delivery item 201 is possible, the temperature recovery instruction information is transmitted from the portable terminal 250 to the delivery box 200 in S316, and the program returns to the process of step S308. After that, when it is determined that the portable terminal 250 receives the determination criterion information in S308, it can be determined that the communication failure with the management server 100 is solved.

When it is determined in the delivering process of S313 that the delivery item 201 is at the predetermined temperature, in S317, the portable terminal 250 performs delivery possibility determination of determining whether delivery of the delivery item 201 by the delivery box 200 is possible or not.

When it is determined in the determining process of S317 that delivery of the delivery item 201 is possible, the program returns to the process of S308. After that, when it is determined that the portable terminal 250 receives the determination criterion information in S308, it can be determined that the communication failure with the management server 100 is solved.

When it is determined in the determining process of S317 that delivery of the delivery item 201 is not possible, whether or not delivery of the delivery item 201 using the delivery box 200 becomes possible by adjustment of at least one of the temperature adjustable time and the delivery prediction time is determined in S318.

When it is determined in the determining process of S318 that delivery does not become possible by the adjustment of any of the temperature adjustable time and the delivery prediction time, delivery cancellation instruction information is transmitted from the portable terminal 250 to the delivery box 200 in S315.

When it is determined in the determining process of S318 that delivery becomes possible by adjustment of at least one of the temperature adjustable time and the delivery prediction time, adjustment instruction information is transmitted from the portable terminal 250 to the delivery box 200 in S319, and the program returns to the process of S308. After that, when it is determined that the portable terminal 250 receives determination criterion information in S308, it can be determined that the communication failure with the management server 100 is solved.

Subsequently, in the portable terminal 250, whether delivery of the delivery item 201 is completed or not is determined in S320. When it is determined in the determining process of S320 that delivery of the delivery item 201 is not completed, the program returns to the process of S307. When it is determined in the determining process of S320 that delivery of the delivery item 201 is completed, delivery completion information is transmitted to the management server 100 and the delivery box 200 in S321, and the delivery process is finished.

The management server 100 determines whether delivery completion information is received from the portable terminal 250 or not in S117. When it is determined in the determining process of S117 that the delivery completion information is not received, the program returns to S118. When it is determined in the determining process of S117 that the delivery completion information is received, the delivery process is finished.

The delivery box 200 determines whether or not the delivery completion information is received from the portable terminal 250 in S215. When it is determined in the determining process of S215 that the delivery completion information is not received, the program returns to S205. When it is determined in the determining process of S215 that the delivery completion information is received, the delivering process is finished.

In the above-described seventh embodiment, by the portable terminal 250, a part of the functions of the delivery box 200 such as the function of communication with the management server 100, the position specifying function, and the display function is replaced. Consequently, the delivery box 200 does not have to have those functions, and the configuration of the delivery box 200 can be simplified.

In the seventh embodiment, when a communication failure occurs between the management server 100 and the portable terminal 250, the delivery possibility determination is performed in the portable terminal 250. Consequently, even in the case where a communication failure occurs during delivery of a delivery item to a delivery destination, the delivery possibility determination can be continuously performed. As a result, the temperature control in the delivery box 200 can be continuously properly performed, and the quality of the delivery item 201 can be maintained.

When a communication failure occurs between the management server 100 and the portable terminal 250 and the delivery possibility determination is performed in the portable terminal 250, communication is not performed between the management server 100 and the portable terminal 250 and, as a result, the communication cost can be reduced.

In the seventh embodiment, in the configuration of making a part of the functions of the delivery box 200 replaced by the portable terminal 250, in the case where a communication failure occurs with the management server 100, the control unit 202 of the delivery box 200 performs the delivery possibility determination. On the contrary, in the configuration that communication is performed directly between the management server 100 and the delivery box 200 without using the portable terminal 250, when a communication failure occurs between the management server 100 and the delivery box 200, the control unit 202 of the delivery box 200 performs the delivery possibility determination.

In the seventh embodiment, the configuration is described in which the function of connecting communication with the communication network 300, the position specifying function, the display function, and the computation processing function among the functions of the delivery box 200 in the first to sixth embodiments are replaced by the portable terminal 250. Alternately, one or plural functions of at least the communication connecting function, the position specifying function, the display function, and the computation processing function may be replaced by the portable terminal 250.

### Eighth Embodiment

Next, an eighth embodiment of the present disclosure will be described. Hereinafter, only parts different from the foregoing embodiments will be described.

In the eighth embodiment, the delivering process after start of delivery is different from that of the seventh embodiment. Concretely, in the eighth embodiment, after start of delivery, the delivery possibility determination is not performed by the management server 100, and the delivery possibility determination is performed by the portable terminal 250.

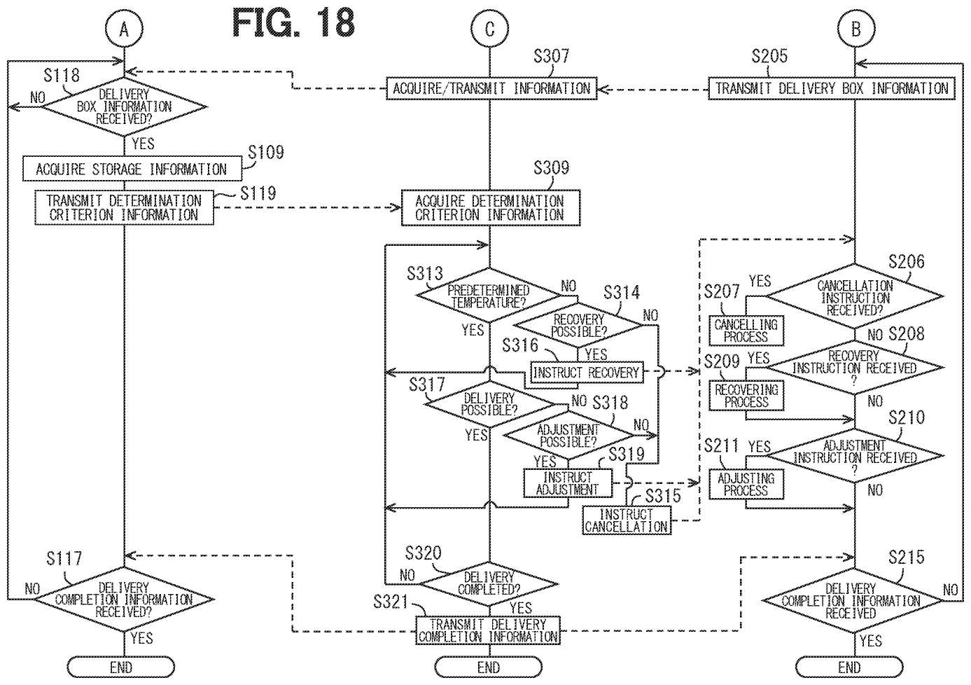

Since the delivery process before delivery start in the eighth embodiment is the same as that described with reference to FIG. 16 in the seventh embodiment, description will not be repeated. Hereinafter, using the flowchart of FIG. 18, parts different from the seventh embodiment in the delivery process after start of delivery by the delivery system of the eighth embodiment will be described.

As illustrated in FIG. 18, in the eighth embodiment, after transmitting the determination criterion information to the portable terminal 250 in S119, the management server 100 determines whether the delivery completion information is received from the portable terminal 250 or not in S117. That is, in the eighth embodiment, the processes of S110 to S116 are not performed and, after start of delivery, the delivery possibility determination by the management server 100 is not performed.

The portable terminal 250 transmits the delivery box information to the management server 100 in S307 and, after that, acquires determination criterion information transmitted from the management server 100 in S309. Subsequently, the processes of S313 to S319 are performed by using the determination criterion information transmitted from the management server.

After transmitting the temperature recovery instruction information from the portable terminal 250 to the delivery box 200 in S316, the program returns to the process of S313. Similarly, after transmitting the adjustment instruction information from the portable terminal 250 to the delivery box 200 in S319, the program returns to the process of S313.

When it is determined in the determining process of S317 that delivery of the delivery item 201 is possible, whether delivery of the delivery item 201 is completed or not is determined in the determining process of S320.

In the above-described eighth embodiment, without performing the delivery possibility determination by the management server 100 after start of delivery, the portable terminal 250 performs the delivery possibility determination. Consequently, the communication frequency between the management server 100 and the portable terminal 250 after start of delivery can be decreased. As a result, the cost of communication between the management server 100 and the portable terminal 250 can be reduced.

The present disclosure is not limited to the foregoing embodiments and can be variously modified as follows without departing from the gist of the present disclosure. The means disclosed in the foregoing embodiments may be properly combined within the executable range.

For example, in the foregoing embodiments, the examples in which the delivery possibility determination unit is configured by the control unit 101 of the management server 100 have been described. However, the delivery possibility determination unit may have a different configuration. For example, the delivery possibility determination unit may be configured by the control unit 202 of the delivery box 200. Alternately, the delivery possibility determination unit may be configured by both the control unit 101 of the management server 100 and the control unit 202 of the delivery box 200.

In the foregoing embodiments, the examples of using a cooling device for cooling the delivery item 201 as the temperature adjustment unit 206 have been described. Alternately, a heating device for heating the delivery item 201 may be used as the temperature adjustment unit 206.

In the configuration of each of the foregoing embodiments, the various sensors 210 of the delivery box 200 may include at least any of a smell sensor for detecting smell in the air-conditioned space in the delivery box 200, a humidity sensor for detecting humidity in the air-conditioned space in the delivery box 200, and a vibration sensor for detecting vibration of the delivery box 200. Quality deterioration of the delivery item 201 may also occur by factors other than temperature such as smell transfer, occurrence of dew condensation, and breakage by vibration. Consequently, by including at least any of a smell sensor, a humidity sensor, and a vibration sensor in the various sensors 210, the management server 100 can perform the delivery possibility determination in consideration of the factors other than temperature exerting influence on the quality of the delivery item 201.

Although the present disclosure has been described in conformity with the embodiments, it is to be understood that the disclosure is not limited to the embodiments and structures. The disclosure also includes various modifications and modifications within an equivalent range. In addition, although various combinations and modes are described in the present disclosure, other combinations and modes including only one element or more or less in those also lie in the scope and the idea range of the present disclosure.

What is claimed is:

1. A delivery system comprising:
a delivery box configured to store a delivery item and to be moved to a delivery destination; and
a management server configured to manage delivery of the delivery item using the delivery box, wherein
the delivery box includes
a power supply,
a temperature adjustment unit configured to adjust a temperature of the delivery item with a power supplied from the power supply, and
a transmission/reception unit configured to, via a communication network, transmit information to the management server and receive information from the management server,
the transmission/reception unit is configured to transmit power supply information, which includes at least a suppliable power amount of the power supply, to the management server,
the management server includes a delivery possibility determination unit configured to execute delivery possibility determination to determine whether the temperature of the delivery item can be maintained at a predetermined temperature by the temperature adjustment unit until the delivery item is delivered to the delivery destination, and
the delivery possibility determination unit is configured to execute the delivery possibility determination based on at least the power supply information.

2. The delivery system according to claim 1, wherein
the delivery box includes a control unit configured to perform control process of the temperature adjustment unit,
the transmission/reception unit is configured to receive, from the management server, a result of the delivery possibility determination, and
the control unit is configured to perform the control process of the temperature adjustment unit based on the result of the delivery possibility determination received by the transmission/reception unit.

3. A delivery system comprising:
a delivery box configured to communicate with a management server, the management server including a delivery possibility determination unit configured to execute determination whether a delivery item can be delivered, the delivery box configured to store the delivery item and to be moved to a delivery destination, wherein
the delivery box includes
a power supply,
a temperature adjustment unit configured to adjust a temperature of the delivery item with a power supplied from the power supply,
a transmission/reception unit configured to, via a communication network, transmit information to the management server and receive information from the management server, and
a control unit configured to perform control process of the temperature adjustment unit,
the transmission/reception unit is configured to transmit power supply information, which includes at least a suppliable power amount of the power supply, to the management server,
the transmission/reception unit is configured to receive, from the management server, a result of delivery possibility determination, which is made by the delivery possibility determination unit based on at least the power supply information, whether the temperature of the delivery item can be maintained at a predetermined temperature by the temperature adjustment unit until the delivery item is delivered to the delivery destination, and
the control unit is configured to perform control process of the temperature adjustment unit based on the result of the delivery possibility determination received by the transmission/reception unit.

4. The delivery system according to claim 2, wherein
the control unit is configured to, when the transmission/reception unit cannot receive the result of the delivery possibility determination from the management server, execute the delivery possibility determination.

5. The delivery system according to claim 1, wherein
the delivery possibility determination unit is configured to execute the delivery possibility determination based on delivery item temperature information relating to the temperature of the delivery item.

6. The delivery system according to claim 5, wherein
the delivery possibility determination unit is configured to acquire the delivery item temperature information based on a temperature of a portion of the delivery box in which the delivery item is stored.

7. The delivery system according to claim 1, wherein
the delivery possibility determination unit is configured to execute the delivery possibility determination before delivery of the delivery item is started.

8. The delivery system according to claim 1, wherein
the delivery possibility determination unit is configured to execute the delivery possibility determination in a period from start of delivery of the delivery item until completion of the delivery.

9. The delivery system according to claim 1, wherein
the delivery possibility determination unit includes
a delivery prediction time acquiring unit configured to acquire a delivery prediction time required to deliver the delivery item to the delivery destination and
a temperature adjustable time acquiring unit configured to acquire a temperature adjustable time in which the temperature adjustment unit is capable of adjusting the temperature of the delivery item to a predetermined temperature with the power supplied from the power supply.

10. The delivery system according to claim 9, wherein
the delivery prediction time acquiring unit is configured to acquire the delivery prediction time based on at least
a distance between the delivery box and the delivery destination and
a travel speed of the delivery box.

11. The delivery system according to claim 9, wherein
the temperature adjustable time acquiring unit is configured to acquire the temperature adjustable time based on at least a suppliable power amount of the power supply.

12. The delivery system according to claim 11, wherein
the temperature adjustable time acquiring unit is configured to acquire the temperature adjustable time based on, additionally, a power consumption per unit time of the temperature adjustment unit.

13. The delivery system according to claim 1, wherein
the delivery possibility determination unit is configured to execute the delivery possibility determination based on operation information relating to an operation state of the temperature adjustment unit.

14. A delivery system comprising:
a delivery box configured to store a delivery item and to be moved to a delivery destination; and
a management server configured to manage delivery of the delivery item using the delivery box, wherein
the delivery box includes
a power supply,
a temperature regulator configured to regulate a temperature of the delivery item with a power supplied from the power supply, and
a transceiver configured to, via a communication network, transmit information to the management server and receive information from the management server,
the transceiver is configured to transmit power supply information, which includes at least a suppliable power amount of the power supply, to the management server, and
the management server includes a processor configured to execute delivery possibility determination to determine, based on at least the power supply information, whether the temperature of the delivery item can be maintained at a predetermined temperature by the temperature regulator until the delivery item is delivered to the delivery destination.

15. A delivery system comprising:
a delivery box configured to communicate with a management server, the management server including a processor configured to execute determination whether a delivery item can be delivered, the delivery box configured to store the delivery item and to be moved to a delivery destination, wherein
the delivery box includes
a power supply,
a temperature regulator configured to regulate a temperature of the delivery item with a power supplied from the power supply,
a transceiver configured to, via a communication network, transmit information to the management server and receive information from the management server, and
a processor configured to perform control process of the temperature regulator,
the transceiver is configured to transmit power supply information, which includes at least a suppliable power amount of the power supply, to the management server,
the transceiver is configured to receive, from the management server, a result of delivery possibility determination, which is made by the processor of the management server based on at least the power supply information, whether the temperature of the delivery item can be maintained at a predetermined temperature by the temperature regulator until the delivery item is delivered to the delivery destination, and
the processor of the delivery box is configured to perform control process of the temperature regulator based on the result of the delivery possibility determination received by the transceiver.
